(19) United States
(12) Patent Application Publication
(10) Pub. No.: US 2009/0137380 A1
(43) Pub. Date: May 28, 2009

(54) SINTERED ALUMINA PRODUCT TRANSPARENT TO INFRARED RADIATION AND IN THE VISIBLE REGION

(75) Inventors: Guillaume Bernard-Granger, Mazan (FR); Christophe Sinet, Sorgues (FR)

Correspondence Address: YOUNG & THOMPSON, 209 Madison Street, Suite 500, ALEXANDRIA, VA, 22314, US

(73) Assignee: Saint-Gobain Centre De Recherche ET D'Etudes Europeen Les Miroirs, Courbevoie (FR)

(21) Appl. No.: 12/158,695

(22) PCT Filed: Dec. 21, 2006
(86) PCT No.: PCT/FR2006/051406

§ 371 Date: Nov. 13, 2008

(30) Foreign Application Priority Data
Dec. 22, 2005 (FR) 0513144

(51) Int. Cl. C04B 35/057; B28B 3/00

(52) U.S. Cl. 501/125; 264/604

(57) ABSTRACT

The invention relates to a sintered alumina product with a density greater than 99.95% of the theoretical density and made for more than 99.95% of its mass from alpha alumina (Al₂O₃) and a dopant selected from Sm₂O₃, CaO and mixtures thereof, the amount of dopant being less than 1000 ppma and the mean particle size of the alumina grains being greater than 0.2 and less than 1.5 μm.

Of application to heat targeting windows or missile heads.

The present invention relates to a new product, resistant and transparent to infrared radiation, but also to visible radiation, notably to manufacture heat targeting windows or missile heads, as well as a method of manufacturing such a product.

Among the materials transparent to infrared radiation, one knows polycrystalline magnesium fluoride in particular. This material cannot however be employed in many applications because of its poor mechanical properties (static mechanical properties, pluvial-erosion, abrasion resistance).

One also knows sapphire, monocrystalline material, which offers both transparency to infrared radiation and good mechanical properties. However, its cost is prohibitive in the majority of cases.

In addition, WO2004/007398 proposes polycrystalline alumina comprising zirconium oxide. This material is described as transparent in the visible region.

Moreover, the search for materials which are resistant and transparent to infrared radiation is very specific. It is distinguished in particular from that relating to materials which are transparent to visible light. Indeed, a material which is transparent in a given wavelength range (in the visible region for example) is not necessarily so in another range. Therefore, nothing makes it possible to think that the material described in WO2004/007398 could be of an interest to transmit an infrared radiation.

EP 1,053, 983 describes alumina-based polycrystalline ceramics, with crystalline particles whose mean size is between 0.3 and 0.7 μm. The raw products described in EP 1,053,983 are obtained by atomization and pressing. The inventors of the present invention noted that such a method does not make it possible to obtain a density greater than 99.95% of the theoretical density of the alumina product considered. The inventors also consider that the transparency to infrared radiation of the products described in EP 1,053,983 is limited.

It will be observed that although EP 1,053,983 describes products with a theoretical density of 100.0%, this density was measured by the traditional method of a buoyancy force in water, defined by JIS R 1634, the measurements being rounded off according to the JIS Z 8401 standard. Taking into account the errors of measurement and the rounding-off applied to these measurements, a measured density of 100% does not mean that the density is indeed greater than 99.95%. With the buoyancy method, it is indeed impossible to measure residual porosities lower than 0.1%, as notably described in the article “Transparent sintered sub-μm Al₂O₃ with IR transmissivity equal to sapphire” by A. Krell, G. Baur, C. Dahne, Window and dome technologies VIII, Proceedings of SPIE, Vol. 5078 (2003), p. 199-207.

EP 1,053,983 also describes the possibility of introducing an oxide of a metal from the 3a and 4a groups, except Ti, in a proportion of less than 2 mol %, and preferably a metallic oxide from the following list: Y₂O₃, Yb₂O₃, ZrO₂, Sc₂O₃, La₂O₃, Dy₂O₃, Lu₂O₃, in a proportion of between 0.02 mol % and 2 mol %.

US 2003/0125189 describes an alumina sintered product obtained from an alumina powder with a purity greater than 99.99%, rather intended for dental applications. Its transparency is measured in a wet state (“wet transmittance”), and thus under favourable conditions. Moreover, the measurement device employed, and notably that of lighting, does not allow to measure an in-line transmittance, but only a total transmittance, the sum of the in-line transmittance (RIT) and the diffuse transmittance. The measurements of total transmittance are thus always greater than or equal to RIT measurements, whatever the considered wavelength. Three-point flexural strength is also less than that of the products of the present invention. Lastly, as in EP 1,053,983, the density measurements described do not make it possible to justify a density greater than 99.95%.

Therefore, there is a permanent need for a material which is resistant, transparent to infrared radiation as well as, to a lesser extent, the visible region, at a reduced cost.

According to the invention, one reaches this object by means of a sintered alumina product with a density greater than 99.95% of the theoretical density and made, for more than 99.95% of its mass, from alpha alumina (Al₂O₃) and, preferably, a dopant selected from Sm₂O₃, CaO and mixtures thereof, the total amount of dopant being less than 1000 ppma [atomic parts par million (10⁶)], and the mean particle size of the alumina grains being between 0.2 and 1.5 μm.

As the following figures and tests illustrate, the product according to the invention advantageously has a high mechanical strength and a very good transparency to infrared radiation.

α alumina and the dopant represent more than 99.95% in mass of the product according to the invention, or “doped product”.

Preferably still, the sintered alumina doped product according to the invention further comprises titanium oxide TiO₂ as additional dopant. In a surprising way, the inventors discovered that adding such dopants improves the transparency to infrared radiation and, in an even more remarkable way, in the visible region, while improving the mechanical strength, notably the three-point flexural strength. Moreover, the cost of the doped product according to the invention remains limited compared to sapphire.

Preferably, the doped product according to the invention still has one and preferably more of the following optional characteristics:
The dopant is selected from Sm₂O₃, preferably without CaO nor TiO₂, and a mixture of CaO and TiO₂, preferably without Sm₂O₃, the atomic ratio CaO/TiO₂ preferably being between 5/95 and 95/5, preferably between 55/45 and 45/55 or between 63/37 and 57/43, and preferably still of 1 or 1.5.
The total amount of dopant is greater than 50 ppma preferably greater than 100 ppma and/or less than 750 ppma, preferably less than 500 ppma, preferably less than 300 ppma, preferably still less than 200 ppma.
The amount of CaO is greater than 25 ppma, preferably greater than 50 ppma and/or less than 500 ppma, preferably less than 375 ppma, preferably less than 250 ppma, preferably less than 150 ppma, preferably still less than 100 ppma.
The amount of TiO₂ is greater than 25 ppma, preferably greater than 50 ppma and/or less than 500 ppma, preferably less than 375 ppma, preferably less than 250 ppma, preferably less than 150 ppma, preferably still less than 100 ppma.
The mean size of the alumina grains is less than 0.7 μm. Still, it is preferred that the mean size of the grains is less than 0.5 μm.
The microstructure of the product according to the invention has a surface density Fv of large grains, i.e. with a size greater than twice the mean size of the other grains, less than 4% in surface, preferably less than 2% in surface, preferably still less than 0.1% in surface. Preferably, the product according to the invention does not comprise grains with a size greater than twice the mean size of the other grains. Hereafter these grains are referred to as “large grains”. The method used to measure the surface density of the large grains (Fv) is described hereafter.
Advantageously, this characteristic provides the product with remarkable transparency to infrared radiation and mechanical performance, notably flexural.
The product according to the invention has a three-point flexural strength at 20° C. greater than 650 MPa, preferably greater than 750 MPa, preferably still greater than 830 MPa, preferably always greater than 950 MPa. The method employed to measure this three-point flexural strength is described hereafter.
The product according to the invention has an in-line transmittance, measured on a sample with a thickness of 1 mm,
   greater than 75%, preferably still greater than 80%, and even greater than 82%, even 83%, for incident radiation wavelengths between 2.5 and 4.5 μm, and/or
   greater than 75%, preferably greater than 78%, preferably still greater than 80% for an incident radiation wavelength of 1.5 μm, and/or
   greater than 60%, preferably greater than 65%, preferably still greater than 70%, and even greater than 74%, for an incident radiation wavelength of 1 μm, and/or
   greater than 24%, preferably greater than 30%, preferably still greater than 35%, even greater than 40%, and even greater than 45% for an incident radiation wavelength of 0.5 μm. For this last wavelength, the in-line transmittance can even exceed 50%.
      The invention further relates to a sintered alumina product made, for more than 99.95% of its mass, from alpha alumina (Al₂O₃) and, preferably, a dopant selected from Sm₂O₃, CaO and mixtures thereof, with TiO₂ as possible additional dopant, the total amount of dopant being less than 1000 ppma and the mean size of the alumina grains being between 0.2 and 1.5 μm, and with an in-line transmittance (RIT), measured on a sample with a thickness of 1 mm,
greater than 75%, preferably greater than 78%, preferably still greater than 80% for an incident radiation wavelength of 1.5 μm, and/or
greater than 60%, preferably greater than 65%, preferably still greater than 70%, and even greater than 74%, for an incident radiation wavelength of 1 μm, and/or
greater than 24%, preferably greater than 30%, preferably still greater than 35%, even greater than 40% or 45%, and even greater than 50%, for an incident radiation wavelength of 0.5 μm, and/or
greater than 75%, preferably still greater than 80%, and even greater than 82%, even 83%, for incident radiation wavelengths between 2.5 and 4.5 μm,

and/or a three-point flexural strength at 20° C. greater than 650 MPa, preferably greater than 750 MPa, preferably still greater than 830 MPa, preferably always greater than 950 MPa.

These properties of the product according to the invention can be measured according to the protocols described in detail hereafter.

Preferably, this product further shows one or more of the preferred characteristics listed above.

The invention also relates to a sintered alumina product made for more than 99.95% of its mass from alpha alumina (Al₂O₃) and, preferably, a dopant selected from Sm₂O₃, CaO and mixtures thereof, with TiO₂ as possible additional dopant, the total amount of dopant being less than 1000 ppma and the mean size of the alumina grains being between 0.2 and 1.5 μm, the product having a surface density Fv of large grains which is less than 4% in surface, preferably less than 2% in surface, preferably still less than 0.1% in surface, and preferably substantially null.

Preferably, this product further shows one or more of the preferred characteristics listed above.

As one will see in more detail hereafter, the inventors discovered that a product according to the invention can be obtained by the implementation of a manufacturing method according to the invention including the following successive stages:
a) preparation of a slurry from an alumina powder whose mean size (average diameter, measured by X-ray sedigraphy and/or X-ray diffraction and/or transmission electron microscopy and/or laser granulometry) of elementary particles is between 0.02 and 0.5 μm,
b) casting the slurry into a porous mould then drying and removing from the mould so as to obtain a green part,
c) drying the removed green part,
d) debindering at a temperature between 350 and 600° C.,
e) sintering at a temperature between 1100 and 1350° C. until a sintered product is obtained, of which the density is at least equal to 92% of the theoretical density and
f) hot isostatic pressing, known as “HIP”, at a temperature between 950 and 1300° C. under a pressure between 1000 and 3000 bars.

The debindering and sintering can be carried out in an atmosphere other than air. On the other hand, for safety reasons, the hot isostatic pressing is preferably carried out in a neutral atmosphere, preferably in argon.

The inventors discovered that casting a slurry makes it possible to provide the product with a density greater than 99.95% of the theoretical density after the complete manufacturing cycle, and that this very high density improves the transparency to infrared radiation.

Preferably, the method according to the invention comprises one or more of the following optional characteristics:
the aggregates of the slurry are made from elementary grains with a mean size between 0.15 and 0.25 μm, preferably of 0.2 μm. Advantageously, the densification of the product is hereby accelerated.
The mould is dried before casting the slurry;
The temperature throughout step b) is between 20 and 25° C.;
The pressure of the slurry inside the mould is between 1 and 1.5 bar;
The hygrometry of mould's environment is maintained between 45 and 55%, preferably between 48 and 52%, throughout step b);
The hot isostatic pressing is carried out at a temperature which is lower than the sintering temperature; preferably the temperature of the hot isostatic pressing is 20 to 100° C., preferably 50 to 100° C. lower than the sintering temperature;
The inventors discovered that, in a method according to the invention, implementing the casting of a slurry, carrying out the hot isostatic pressing at a temperature which is lower than the sintering temperature decreases the surface density of large grains Fv. Thanks to this additional characteristic, the microstructure of the product according to the invention can comprise less than 4% in surface of large grains (Fv), and even substantially no large grains. It results in an improved in-line transmittance and a remarkable flexural strength.
Classically, in step a), the dispersion, in the slurry, of the alumina powder grains is improved thanks to the addition of balls, called “grinding balls”. Preferably, the alumina content of these balls is, according to the invention, greater than 99.5% in volume. This characteristic advantageously limits the number of large grains, and thus further improves the in-line transmittance and the flexural strength of the product obtained. These balls are removed from the slurry before the slurry is shaped.

In a first embodiment, at step a), a slurry is prepared so that the product obtained at the end of step f) is substantially only made up of alumina (more than 99.95% alumina in weight), the other species likely to be found in the end product being impurities which are necessarily introduced with the alumina powder.

In step e), sintering is carried out until a sintered product is obtained, of which the density is at least equal to 92% of the theoretical density of alumina.

The method according to this first embodiment therefore makes it possible to manufacture products which are very transparent in the infrared region, without needing to add dopant to the slurry. The manufacturing method is hereby advantageously simplified.

An alumina sintered product according to the invention, in particular manufactured according to the first embodiment of the method according to the invention, comprises, in percentage by mass, more than 99.95% of alpha alumina (Al₂O₃), the mean size of the alumina grains being between 0.2 and 1.5 μm, and has a density greater than 99.95% of the theoretical density of the alumina (3.976 grams per cubic centimetre).

As the following figures and tests illustrate, this non-doped sintered alumina product advantageously has a high mechanical strength and a very good transparency to infrared radiation.

Preferably, the mean size of the alumina grains of this non-doped sintered alumina product is greater than 0.3 μm, preferably still greater than 0.45 μm and/or less than 1.0 μm, preferably still less than 0.75 μm.

In a second embodiment, at step a), at least one dopant is added, chosen from the group formed by Sm₂O₃, CaO, precursors of these oxides and mixtures of these oxides and/or these precursors. Preferably, titanium oxide TiO₂ or a precursor of the latter is further added. Preferably, the amount of dopant is determined in such a way that the product obtained at the end of step f) is a doped product according to the invention. Preferably, at step a), the dopant(s) is/are added voluntarily, i.e. systematically and methodically, in quantities which guarantee that the sintered product obtained at step f) is in accordance with the invention.

Preferably, at step a), the ratio between the average diameter of the dopant powder particles and the average diameter of the alumina powder particles is less than or equal to 1.

In this second embodiment, the sintering at step e) is continued until a sintered product is obtained, of which the density is at least equal to 92% of the theoretical density of the alumina product, doped during manufacturing.

The inventors discovered that it is advantageous that the sintering temperature is between 1280° C. and 1350° C. Advantageously, the duration of the sintering step is hereby reduced.

Therefore, the method according to this second embodiment makes it possible to manufacture very transparent products, not only in the infrared region, but also in the visible region. The addition of these specific dopants also improves the mechanical strength of the product.

The invention also relates to a product obtained by a method according to the invention.

Finally, the invention relates to the use of a product obtained by a method according to the invention, or of a product according to the invention, doped or not, such as heat targeting windows or missile heads.

In fact, the remarkable in-line transmittance and flexural strength of the product according to the invention make it specifically adapted to these applications.

Finally, the invention relates to a preparation method of slurry comprising alumina powder suspended in a liquid, the balls being moved within said liquid to facilitate said suspension. This method is remarkable in that the alumina content of these balls is greater than 99.5% vol.

Preferably, this method is implemented as part of step a) of a manufacturing method according to the invention, so as to manufacture a sintered alumina product according to the invention. Advantageously, it results in a limited number of large grains in the product obtained.

Other characteristics and advantages of the invention will appear with the reading of the specification hereafter and with the examination of the drawings, in which:

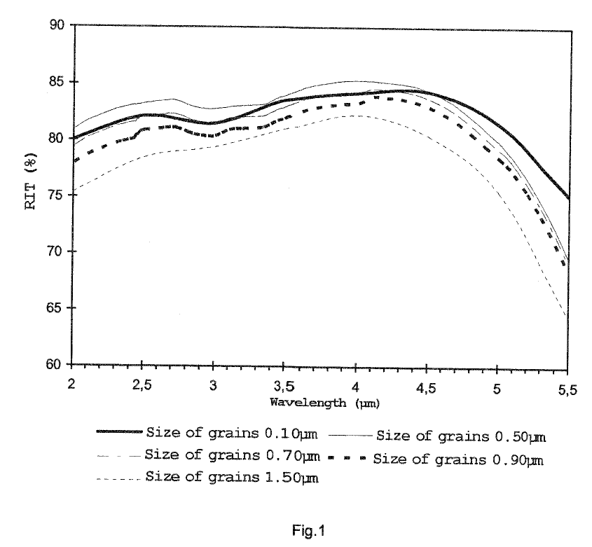

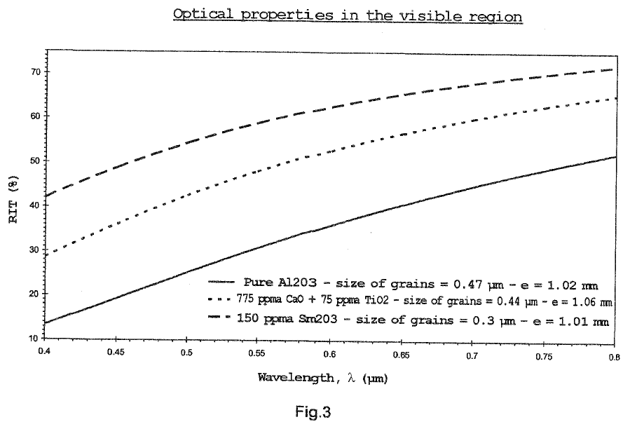

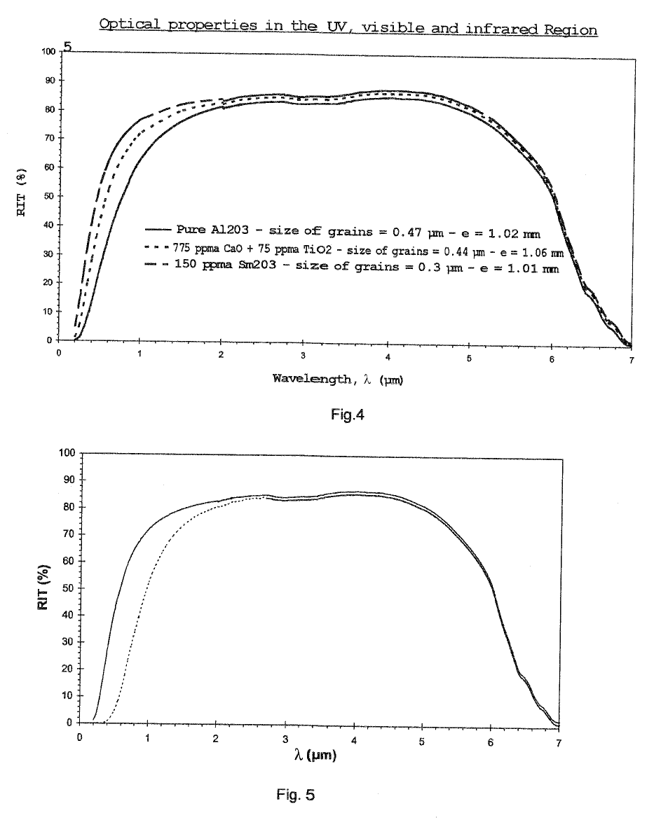

FIGS. 1 (relating to non-doped products), 3 and 4 represent curves illustrating in-line transmittance (RIT) measurements of various products, manufactured with the method according to the invention, according to the incident radiation wavelength, FIGS. 3 and 4 making it possible to measure the effect of the presence of dopants according to the invention in the visible and infrared regions, respectively;

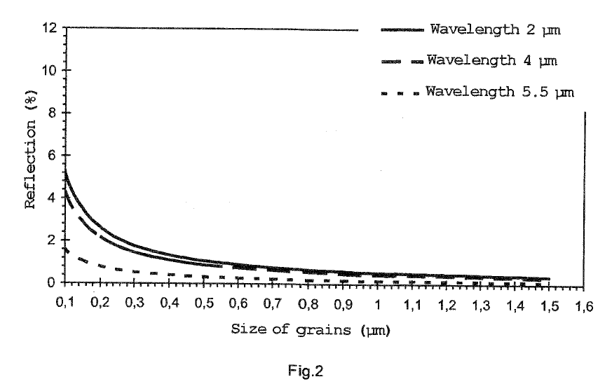

FIG. 2 represents the curves which illustrate the calculations of the reflectance of various non-doped products, manufactured with the method according to the invention, according to the mean size of the grains, for various incident radiation wavelength values;

FIG. 5 illustrates, as an example, the actual curve of in-line transmittance (RIT) measurements for a sample with a porosity to be determined, and the corresponding modelled curve of the same product without porosity.

Classically, “size” or “diameter” of a grain or a particle is the average dimension thereof. A “powder” is a group of particles which themselves can be agglomerates of grains. “Grains” means the elements forming these agglomerates. Notably, these grains are found in the form of alumina crystals in the end product. The “mean size” of particles or grains of a mixture of particles or a group of grains is the average of the sizes of these particles or grains.

In a similar way, the “size” of a pore is its mean dimension. The “mean size” of the pores of a material is the average of the sizes of these pores.

At step a) of the manufacturing method according to the invention, slurry is prepared from an alumina powder.

“Slurry” means a substance formed by suspending particles in a liquid, generally water or an organic solvent (alcohol for example), with or without additives such as dispersants, deflocculants, polymers, etc. Preferably, the slurry comprises a temporary binder, i.e. removed from the product during sintering.

In the first embodiment of the method according to the invention, the purity of the alumina powder is determined in a manner known per se, so that the end sintered alumina product obtained by the method according to the invention comprises, in percentage by mass, more than 99.95% of Al₂O₃. Typically, the purity of the powder used is greater than 99.97% in volume.

The mean size of the alumina grains of the end product also depends, in a known manner, on the mean size of the alumina powder particles used at step a). So that the mean size of the grains of the end product is between 0.2 and 1.5 μm, the mean size of the particles (average diameter) of the powder used is selected between 0.02 and 0.5 μm.

Preferably, the mean size of the particles of the powder used is selected so that the mean size of the alumina grains of the end product is greater than or equal to 0.3 μm and/or less than 1.0 μm, preferably still less than 0.75 μm. The mean size of the particles of the powder used can also be selected so that the mean size of the alumina grains of the end product is greater than or equal to 0.45 μm.

Preferably, according to the second embodiment of the method according to the invention, a dopant selected from Sm₂O₃ and a mixture of CaO and TiO₂ is introduced to the alumina slurry. Precursors of these dopants can also be used. “Precursor of a dopant” means an element which, during the manufacture of the product according to the invention, is transformed into said dopant.

In the case of a mixture of CaO and TiO₂, and/or precursors of the latter, the proportions are determined so that the atomic ratio CaO/TiO₂ is preferably between 5/95 and 95/5, preferably between 55/45 and 45/55 or between 63/37 and 57/43, and preferably still of 1 or 1.5. The inventors noted particularly satisfactory results with these last two ratios.

The total amount of dopant and precursors is determined in such as way that, in the doped end product, the amount of dopant is greater than 50 ppma, preferably greater than 100 ppma and/or less than 750 ppma, preferably 500 ppma, preferably 300 ppma, preferably still less than 200 ppma. If the dopant is a mixture of CaO and TiO₂, preferably without Sm₂O₃, this determination is carried out in such as way that, in the end product, the atomic ratio CaO/TiO₂ is preferably between 5/95 and 95/5, preferably between 55/45 and 45/55 or between 63/37 and 57/43, and preferably still of 1 or 1.5, and that the amounts of CaO and TiO₂ are each preferably greater than 25 ppma, preferably greater than 50 ppma and/or less than 500 ppma, preferably less than 375 ppma, preferably less than 250 ppma, preferably less than 150 ppma, preferably still less than 100 ppma.

In this second embodiment, the size of the powder particles used is selected in such a way that the mean size of the alumina grains of the end product is greater than 0.2 μm and less than 1.5 μm, preferably less than 0.7 μm, preferably still less than 0.5 μm.

The slurry can be manufactured in a container according to techniques known by one skilled in the art, by mixture and homogenization of the alumina powder, the dopant powder or that of possible precursor(s) of dopant, and of the desired quantity of liquid.

Preferably the slurry comprises more than 60% dry matter.

Preferably still, the container containing the slurry can temporarily be put under a vacuum pressure, preferably greater than 0.5 bar, to best eliminate the residual bubbles of air from the slurry.

Preferably, the mould is dried beforehand. Advantageously, the setting time during step b) of drying is reduced.

The temperature during the casting and preform shaping operations is preferably maintained between 20 and 25° C.

After filling the mould, at least one porous wall of the mould absorbs, at least partly, the slurry liquid. The complete filling of the mould and the removal can be further assisted by putting the inside of the mould under vacuum pressure, for example by using a feed column, whose height is adapted to the geometry of the part. Preferably, the pressure of the slurry inside the mould is between 1 and 1.5 bar. Advantageously, the density of the green part is thus increased and/or that makes it possible to shape parts with a thickness greater than 3 millimetres.

Preferably still, the hygrometry of the air surrounding the mould is maintained between 45 and 55%, preferably between 48 and 52%, throughout step b). Advantageously, the drying time is thus controlled.

As the liquid is evacuated, the alumina particles, and possibly those of dopant, immobilize each other. This immobilization is called “setting of the preform”. However, residual porosity between the immobilized particles authorizes the crossing of the liquid.

Complementary slurry is preferably introduced into the mould as the liquid is absorbed. Advantageously, a portion of volume left empty by the liquid is thus filled by alumina particles and possible those of dopant of the complementary slurry.

After the moisture of the part in the mould has become less than 2%, it is considered that it underwent sufficient drying to ensure its integrity and the maintenance of its geometry during its handling after removal from the mould. The mould therefore contains a “preform” and any complementary supply of slurry is stopped. Next, the preform is removed from the mould to obtain a green part, or “green”.

At step c), the green part undergoes a complementary drying, for example by storage in an oven with controlled temperature and hygrometry, according to traditional methods.

At step d), the dried green part undergoes a debindering, preferably under air, at a temperature between 350 and 600° C. The debindering is an operation known per se, intended to remove organic materials from the green part.

At step e), the dried and debindered green part, or “blank”, is sintered, i.e. densified and consolidated by a heat treatment.

Classically, the blank is placed in a medium, preferably air, in which the temperature varies in relation to the time according to a predetermined cycle. The heat treatment includes a phase during which the temperature of the medium surrounding the part rises, then a phase during which the temperature is maintained at a temperature between 1100 and 1350° C., or “sintering stage”, or if dopant is present, preferably between 1280 and 1350° C., then finally a phase during which the temperature falls. Sintering can be carried out in a traditional oven or by SPS (Spark Plasma Sintering) or MWS (MicroWave Sintering).

The duration of the sintering stage is preferably between 0 and 20 hours. In a traditional oven, the speeds of rise/fall in temperature are between 50 and 150° C./hour. For sintering by SPS or MWS, they are between 20 and 400° C./minute.

Sintering causes a volumetric shrinkage, and thus densification of the part. It is possible to obtain a density after sintering which is greater than or equal to 92% of the theoretical density of the product, i.e., in the absence of dopant, of alumina. This limit is considered as necessary by one skilled in the art, to obtain after the next step f) (HIP), a density greater than 99.95% of the theoretical density of alumina or, if necessary, of the mixture of alumina and dopants.

At step f), the sintered part resulting from the sintering of the blank undergoes, after cooling, a thermal after-treatment under pressure known as “HIP” (“Hot Isostatic Pressing”, i.e. hot isostatic pressing, or “compression”), preferably under neutral gas (argon for example).

The hot isostatic pressing (HIP) is carried out in an enclosure, the temperature of which is between 950 and 1300° C., under a pressure between 1000 and 3000 bars. The temperature within the enclosure is preferably less than the sintering temperature. Preferably still, the temperature within the enclosure is 20 to 100° C. lower than the sintering temperature.

The duration of the temperature maintenance stage during the hot isostatic pressing (HIP) is preferably between 15 minutes and 24 hours.

The operation of hot isostatic pressing (HIP) makes it possible to further increase the density of the parts by removing the residual porosity which could be present after sintering, and to close up certain structural defects (microscopic cracks), thus improving the mechanical aspect of the ceramic parts.

In the first embodiment of the method according to the invention, at the end of step f), a sintered alumina product is obtained, comprising, in percentage of mass, more than 99.95% of alumina (Al₂O₃), the mean size of the alumina grains being between 0.2 and 1.5 μm, and having a density greater than 99.95% of the theoretical density of alumina.

In the second embodiment of the method according to the invention, at the end of step f), a doped sintered alumina product according to the invention is obtained, in which the alumina and dopant represent more than 99.95% of the product mass, with a density greater than 99.95% of the theoretical density, the mean size of the alumina grains being between 0.2 and 1.5 μm.

According to this preferred embodiment of the invention, one notes that, in a surprising way, no presence of large grains could be detected. The product does not comprise abnormal crystalline growth. In a more general way, the product comprises less than 4%, preferably less than 2%, preferably less than 0.1%, preferably still substantially no “large grains”.

A “large grain” is a grain with a size greater than twice the mean size of the other grains, the size being measured by an analysis carried out on images obtained by scanning microscopy.

Advantageously, this characteristic notably improves the mechanical and optical performance of the product according to the invention.

Adding a dopant selected from Sm₂O₃, CaO, their precursors, and mixtures thereof, and possibly, notably in the presence of CaO, TiO₂ or a precursor of TiO₂, also improves the transparency of the product in the infrared as well as in the visible region. Advantageously, adding such dopants also obviates any additional annealing step after hot isostatic pressing (HIP).

The following non-restrictive examples are given to illustrate the invention.

Samples are prepared in the following way, according to a method of the invention.

### EXAMPLE 0

A slurry in the form of a 65% dry matter suspension is prepared by mixing in a jar mill, a dispersant, an organic binder and alumina powder with a purity greater than 99.97%, and whose median diameter d50 of the aggregates is 10 μm, composed of elementary grains having a d50 of 0.2 μm. The grinding balls are 99% in volume alumina.

Advantageously, the method according to the first embodiment of the invention makes it possible to manufacture products which are transparent in the infrared region without adding dopant such as magnesium oxide.

The slurry thus prepared is deaerated and casted into a plaster mould which has been dried in an oven beforehand for 48 hours at 50° C. During the casting and support in the mould, the temperature is maintained at 23° C., the room temperature being at atmospheric pressure and presenting 50% hygrometry.

After a first drying in the mould, then removal from the mould, the green part undergoes additional drying and a debindering under air for 3 hours at 480° C., then is left to rest in ambient temperature and pressure conditions for 2 days.

The blank obtained is then sintered under air at 1250° C. for 3 hours. Finally, the sintered part undergoes hot isostatic pressing (HIP) at 1200° C. for 15 hours.

The inventors noted that the microstructure of the product obtained comprised 3.5% in surface of “large grains” and presented a transparency to infrared radiation and remarkable mechanical performance.

The infrared radiation can be transmitted, reflected or diffused. Classically, a material is known as “transparent” to infrared radiation when it is able to transmit this radiation in-line, i.e. it presents a high in-line transmittance (RIT, or “Real in Line Transmittance”). For a pure material, when the measured RIT values are close to the theoretically calculated RIT values, taking into account the refraction index of the material, the diffusion is insignificant. A pure material is all the more “transparent” when it presents a high RIT value and a weak reflection.

To evaluate the transparency, the parts are rectified and polished to reach mirror quality. After this preparation, the products present a Ra<10 nm (Ra: “average Roughness”) and a thickness “e” of 1 mm. The RIT in the region of the infrared wavelengths is then measured, i.e. between 2 and 6 μm.

The reflection is also calculated, according to the size of the grains, for different infrared wavelengths.

The mean size of the grains was measured by a “Mean Linear Intercept” method, based on the analysis of images obtained by scanning microscopy, from breaking patterns. A method of this type is described in the ASTM (American Linear Intercept Method) method: NPA 04102. The results obtained by this method were multiplied by a correction coefficient equal to 1.2, to take the three-dimensional aspect into account.

The density of a product was evaluated in the following way: the mean size of the grains and the mean size of the pores as well as a curve providing the RIT transparency according to the incident wavelength (“real curve”) were determined, from measurements of the product. In a traditional manner, the sizes can be determined by the ASTM (American Linear Intercept Method) method: NPA 04102 applied to a polished section of the product.

A theoretical curve representing the RIT transparency according to the incident wavelength for a theoretical material identical to that of the product, but having a density of 100% (null residual porosity) was then traced by means of a model, for example of the model described in “Transparent alumina: a light scattering model” by R. Apetz and M. P. B. Van Bruggen, J. Am. Ceram. Soc. 86, p. 480-486, (2003). This model provides an evaluation of the in-line transmittance according to the residual porosity, of the mean size of grains and of the mean size of pores.

The difference between the two curves (theoretical transparency and product transparency which is actually measured) is the consequence of the presence of residual porosity. In the above-mentioned model, by increasing the residual porosity value, while maintaining the mean size of grains and mean size of pores values identical to the corresponding sizes measured on the product, the curve plotted using the model is close to the theoretical curve, almost overlapping it. It is considered that there is “overlapping” when the coefficient of correlation R² is equal to or greater than 0.995. Of course, if that is possible however, a higher coefficient of correlation is sought out.

The value of residual porosity used to plot the theoretical curve overlapping the real curve is an evaluation of the real residual porosity of the product. The product density can then be determined using this evaluation.

FIG. 5 illustrates, as an example, the initial difference between the real curve (broken line) of a sample with a porosity to be determined, and the corresponding theoretical curve (full line), i.e. for a theoretical material with a density of 100% (null porosity), with a mean size of grains and a mean size of pores identical to those of said sample, i.e. a mean size of measured grains of 0.41 μm and a mean size of measured pores of 0.15 μm. In this example, a residual porosity of 0.05% makes it possible, by means of the model, to build a mathematical theoretical curve identical to the RIT curve experimentally measured. Thus, the density of the sample is 99.95% of the theoretical density. As a comparison, a measurement of density using the buoyancy method would give a density of 100% of the theoretical density.

The method used to measure the surface density of large grains Fv is as follows: a section of the product is polished until a mirror quality polish is obtained. After polishing, a thermal etching at a temperature 50 to 80° C. lower than the temperature of sintering is carried out, for 0.5 hours. A photograph, of the total area AT, is then taken by Electronic Sweeping Microscopy. On this photograph, the large grains are polygonised through an analysis of the image, and the total area represented by the large grains is calculated: AGG. The “surface density” of large grains Fv is the ratio of the total area of large grains AGG divided by the total area AT, multiplied by 100.

The mechanical strength of the sintered parts is measured in three-point flexural mode on specimens with dimensions of 40 mm*4 mm*3 mm, with a distance between supports equal to 20 mm and a crossing speed equal to 0.5 mm/min, by means of a Lloyd press, LR150K model.

The curves of FIG. 1 show that to have a RIT greater than 70% for a wavelength between 2.5 and 5 μm, a mean size of grains which is less than 1.5 μm is needed. Preferably, a RIT greater than 80% between 2.5 and 5 μm is desired, which corresponds to products with a mean size of grains which is less than 1 μm.

One notes on the curves of FIG. 2 that if the mean size of the grains is less than 0.2 μm, the reflection is no longer insignificant. The transparency in the infrared region is therefore decreased. Surprisingly, it is therefore necessary to impose a limit lower than 0.2 μm to optimize the transparency. This teaching is contrary to that of EP 1,053,983, according to which the transparency of material would be improved by reducing the mean size of the grains to less than 0.3 μm.

The following table 1 provides the results of the measurement tests of the three-point flexural strength.

TABLE 1

| | | |
|---|---|---|
| Mean size of grains (μm) | 0.50 | 0.70 |
| Three-point flexure at 1000° C. (MPa) | 414 | 437 |
| Three-point flexure at 20° C. (MPa) | 698 | 612 |

It appears that the mechanical three-point flexural strength of the sintered products manufactured according to the first embodiment of the method according to the invention is very satisfactory.

The following non-restrictive examples 1 and 2 are given to illustrate the invention in the case of product doping.

Samples are prepared in the following way in accordance with a method according to the invention.

### EXAMPLE 1

A slurry in the form of a 65% dry matter suspension is prepared by mixing in a jar mill, a dispersant, an organic binder and alumina powder with a purity greater than 99.97%, and whose median diameter d50 of the aggregates is 10 μm, the aggregates being composed of elementary grains having a median diameter d50 of 0.2 μm, and samarium oxide powder (Sm₂O₃) with a median diameter d50 equal to 5 μm, in an amount of 150 ppm atomic. The grinding balls, used to improve the suspension of the alumina powder, are made from over 99.5% vol. alumina.

The slurry thus prepared is deaerated and casted into a plaster mould which has been dried beforehand for 48 hours at 50° C. During the casting and time spent in the mould, the temperature is maintained at 23° C., the room temperature being at atmospheric pressure and presenting 50% hygrometry.

After the first drying in the mould, then removal from the mould, the green part undergoes additional drying and a debindering under air for 3 hours at 480° C., then is left to rest in ambient temperature and pressure conditions for 2 days.

The blank obtained is then sintered under air at 1315° C. for 30 minutes. Finally, the sintered part then undergoes hot isostatic pressing (HIP) at 1265° C. for 15 hours.

### EXAMPLE 2

A mixture of CaCO₃ and TiO₂ powder is ground in a jar mill containing 99% vol. alumina balls, for the time necessary to reach a mean size of particles which is less than or equal to the mean size of the particles of the alumina powder, which are also included in the composition of the product.

A slurry in the form of a 65% dry matter suspension is prepared by mixing in a jar mill, a dispersant, an organic binder and alumina powder with a purity greater than 99.97%, and whose median diameter d50 of the aggregates is 10 μm, the aggregates being composed of elementary grains having a median diameter d50 of 0.2 μm, and the mixture of ground CaCO₃+TiO₂, introduced so that in the end product, the quantities of CaO and TiO₂ are of 75 ppm atomic each, for a dopant total of 150 ppm atomic. The grinding balls, used to improve the suspension of the alumina powder, are made from over 99.5% vol. alumina.

The slurry thus prepared is deaerated and casted into a plaster mould which has been dried in an oven beforehand for 48 hours at 50° C. During the casting and time spent in the mould, the temperature is maintained at 23° C., the room temperature being at atmospheric pressure and presenting 50% hygrometry.

After the first drying in the mould, then removal from the mould, the green part undergoes additional drying and a debindering under air for 3 hours at 480° C., then is left to rest in ambient temperature and pressure conditions for 2 days.

The blank obtained is then sintered under air at 1285° C. for 15 minutes. Finally, the sintered part undergoes hot isostatic pressing (HIP) at 1200° C. for 15 hours.

### EXAMPLE 3

The product of example 3 is manufactured under the same conditions as the product of example 1, except that the step of hot isostatic pressing (HIP) is carried out at 1275° C. for 15 hours.

The following table 2 summarizes the results obtained.

TABLE 2

| Examples | 0 | 1 | 2 | 3 |
|---|---|---|---|---|
| Size of grains (μm) | 0.47 | 0.3 | 0.44 | 0.5 |
| Sintering temperature (° C.) | 1250 | 1315 | 1285 | 1250 |
| Density after sintering | 97.2 | 94.3 | 95 | 96.8 |
| (% of the theoretical | | | | |
| density) | | | | |
| HIP temperature (° C.) | 1200 | 1265 | 1200 | 1275 |
| Density after HIP (% of | >99.99 | >99.99 | >99.99 | >99.99 |
| the theoretical density) | | | | |
| HIP temp. < Sintering | yes | yes | yes | no |
| temp.? | | | | |
| Surface density of large grains | 3.5% | 0% | 0% | 7% |
| Three-point flexure at | 698 | 972 | 847 | 430 |
| 20° C. (MPa) | | | | |
| RIT (%) at 0.6 μm | 36 | 63 | 53 | — |

Table 2 above is used to observe that the doped products according to the invention do not show abnormal growth of the grains. These products reach a very satisfactory mechanical strength.

In addition, table 2 and FIGS. 3 and 4 confirm that doping according to the invention improves RIT transmittance. This improvement is noted for whatever wavelength, and, which is particularly remarkable, in the visible region.

The use of Sm₂O₃ gives the best performance in relation to mechanical strength and transparency.

The use of the mixture of CaO+TiO₂ dopants is also effective, and moreover economically interesting, these oxides being more available.

The product of example 3 shows the interest to implement a hot isostatic pressing HIP at a temperature lower than the sintering temperature, to decrease the rate of large grains.

In addition, the inventors noted, on the examples, that the products according to the invention have a mean size of pores which is less than 0.5 times the mean size of grains, preferably between 0.3 and 0.5 times the mean size of grains.

As that appears clearly now, the invention thus makes it possible to manufacture a very dense and very homogeneous product, which only disturbs the passage of the infrared radiation to a small extent. Advantageously, this product, resistant and transparent in the infrared region, is at a reduced cost.

The doping of the product according to the invention leads to products which are also very dense, without abnormal growth of grains. It advantageously provides a high mechanical strength and a very good transparency in the wavelengths of the visible light and in those of the infrared region.

Of course, the present invention is not limited to the described embodiments, provided as illustrative and non-restrictive examples.

1-29. (canceled)

30. A sintered alumina product with a density greater than 99.95% of the theoretical density and made, for more than 99.95% of its mass, from alpha alumina (Al₂O₃) and a dopant selected from Sm₂O₃, CaO and mixtures thereof, the amount of dopant being less than 1000 ppma and the mean particle size of the alumina grains being between 0.2 and 1.5 μm.

31. The product according to claim 30 comprising moreover titanium oxide TiO₂ as an additional dopant.

32. The product according to claim 31 comprising a mixture of CaO and TiO₂ as the only dopant.

33. The product according to claim 32, wherein the atomic ratio CaO/TiO₂ is between 55/45 and 45/55 or 63/37 and 57/43.

34. The product according to claim 33, wherein the atomic ratio CaO/TiO₂ is 1 or 1.5.

35. The product according to claim 30 wherein the total amount of dopant is greater than 100 ppma and/or less than 200 ppma.

36. The product according to claim 31, wherein the content of each one of dopants CaO and TiO₂ is greater than 25 ppma and/or less than 500 ppma.

37. The product according to claim 30, wherein the mean size of grains is less than 0.7 μm.

38. The product according to claim 37, wherein the mean size of grains is less than 0.5 μm.

39. The product according to claim 30, comprising a surface density (Fv) of grains with a size greater than twice the mean size of other grains less than 4% in surface.

40. The product according to claim 39, comprising a surface density (Fv) of grains with a size greater than twice the mean size of other grains less than 0.1% in surface.

41. The product according to claim 40, not comprising grains with a size greater than twice the mean size of other grains.

42. The product according to claim 30, with a three-point flexural strength at 20° C. greater than 830 MPa.

43. The product according to claim 42, with a three-point flexural strength at 20° C. greater than 950 MPa.

44. The product according to claim 30, presenting an in-line transmittance (RIT), measured on a sample with a thickness of 1 mm,
greater than 75% for an incident radiation wavelength of 1.5 μm, and/or
greater than 65%, for an incident radiation wavelength of 1 μm, and/or
greater than 30%, for an incident radiation wavelength of 0.5 μm, and/or
greater than 82% for incident radiation wavelengths between 2.5 and 4.5 μm.

45. The product according to claim 44, presenting an in-line transmittance (RIT), measured on a sample with a thickness of 1 mm,
greater than 78% for an incident radiation wavelength of 1.5 μm, and/or
greater than 70%, for an incident radiation wavelength of 1 μm, and/or
greater than 35%, for an incident radiation wavelength of 0.5 μm, and/or
greater than 83% for incident radiation wavelengths between 2.5 and 4.5 μm.

46. A sintered alumina product made for more than 99.95% of its mass from alpha alumina (Al₂O₃) and a dopant selected from Sm₂O₃, CaO, TiO₂, and mixtures thereof, the amount of dopant being less than 1000 ppma and the mean particle size of the alumina grains being between 0.2 and 1.5 μm, and presenting an in-line transmittance (RIT), measured on a sample with a thickness of 1 mm,
greater than 75% for an incident radiation wavelength of 1.5 μm, and/or
greater than 65%, for an incident radiation wavelength of 1 μm, and/or
greater than 30%, for an incident radiation wavelength of 0.5 μm, and/or
greater than 82% for incident radiation wavelengths between 2.5 and 4.5 μm,
and/or a three-point flexural strength at 20° C. greater than 650 MPa.

47. The product according to claim 46, presenting an in-line transmittance (RIT), measured on a sample with a thickness of 1 mm,
greater than 78% for an incident radiation wavelength of 1.5 μm, and/or
greater than 70%, for an incident radiation wavelength of 1 μm, and/or
greater than 35%, for an incident radiation wavelength of 0.5 μm, and/or
greater than 83% for incident radiation wavelengths between 2.5 and 4.5 μm,
and/or having a three-point flexural strength at 20° C. greater than 830 MPa.

48. The product according to claim 46, wherein the dopant is selected from CaO, TiO₂, and mixtures thereof.

49. A method of manufacturing a sintered alumina product including the following successive steps:
a) preparation of a slurry from an alumina powder whose mean size of the elementary particles is between 0.02 and 0.5 μm, and from at least one dopant selected from Sm₂O₃, CaO, TiO₂, the precursors of these dopants, and mixtures of these dopants and/or these precursors,
b) casting of the slurry in a porous mould then drying and removal from the mould so as to obtain a green part,
c) drying of the green part removed from the mould,
d) debindering at a temperature between 350 and 600° C.,
e) sintering at a temperature between 1100 and 1350° C. until a sintered product is obtained, of which the density is at least equal to 92% of the theoretical density of the alumina of the doped alumina product obtained at step f), and
f) hot isostatic pressing, known as “HIP”, at a temperature between 950 and 1300° C., under a pressure between 1000 and 3000 bars,
the amount of dopant being determined so that the product obtained at the end of step f) is a doped product according to claim 30.

50. The method of manufacturing a sintered alumina product according to claim 49, wherein hot isostatic pressing is carried out at a temperature which is lower than the sintering temperature.

51. The method of manufacturing a sintered alumina product according to claim 50, wherein the temperature of the hot isostatic pressing is 20 to 100° C. lower than the sintering temperature.

52. The method of manufacturing a sintered alumina product according to claim 50, wherein the temperature of the hot isostatic pressing is 50 to 100° C. lower than the sintering temperature.

53. The method of manufacturing a sintered alumina product according to claim 49, wherein the sintering temperature is between 1280° C. and 1350° C.

54. The method of manufacturing a sintered alumina product according to claim 49 wherein, at step a), grinding balls are used to improve the suspension of the alumina powder, the alumina content of said grinding balls being greater than 99.5% vol.

55. The method of manufacturing a sintered alumina product according to claim 49 wherein, at step a), the ratio between the average diameter of the dopant particles and the average diameter of the alumina particles is less than or equal to 1.

56. The method of manufacturing a sintered alumina product according to claim 49 wherein, at step a), the aggregates of the slurry are made from elementary grains with a mean size between 0.15 and 0.25 μm.

57. A product obtained following a method according to claim 49.

58. Heat targeting window or missile head made of a product according to claim 30.
